(19) United States
(12) Patent Application Publication
(10) Pub. No.: US 2024/0240451 A1
(43) Pub. Date: Jul. 18, 2024

(54) STRUCTURE TO ENHANCE THE EMBEDDING AND FIXING STRENGTH BETWEEN THE CONCRETE AND THE EXTENDING COMPONENT EMBEDDED INSIDE THE CONCRETE

(71) Applicants: Chi-wan HSIEH, Kaohsiung City (TW); Chi-feng LEE, New Taipei City (TW)

(72) Inventors: Chi-wan HSIEH, Kaohsiung City (TW); Chi-feng LEE, New Taipei City (TW)

(21) Appl. No.: 18/395,577

(22) Filed: Dec. 24, 2023

(30) Foreign Application Priority Data
Jan. 18, 2023 (TW) 112102358

(51) Int. Cl. E04B 1/41; F16B 35/04; F16B 39/02

(52) U.S. Cl. CPC E04B 1/4178; E04B 1/4114; F16B 35/041; F16B 39/021

(57) ABSTRACT

A structure, which enhances the embedding and fixing strength between the concrete and the extending component embedded inside the concrete, includes: the external surface of the shaft part having an integrally formed protruding structure; the center of the shaft part having a central channel; the top end of the central channel communicating with the hole of the tip end, on both sides of the central channel; a plurality of transverse holes communicating with the central channel and configured from top to bottom; and the transverse holes distributed between one protruding structure and another.

### CROSS-REFERENCE TO RELATED APPLICATION

This application claims the benefit of and priority to Taiwanese Patent Application No. 112102358 filed on Jan. 18, 2023, which are herein incorporated by reference in its entirety.

### FIELD OF THE INVENTION

The present invention relates to a structure to enhance the embedding and fixing strength between the concrete and the extending component embedded inside the concrete, and more particularly to a structure with a central channel formed inside the extending component and a plurality of transverse holes serially connecting the central channel, such that an anchoring adhesive can administered into the extending component, and through the guidance of the central channel, the anchoring adhesive can go through the serially connected plurality of transverse holes to fill up the hole inside the concrete for placing the extending component, thus enhancing the encasing strength and embedding and fixing strength between the extending component and the concrete. When connecting the extending component and the reinforcing steel bar, the present invention can effectively increase the embedding and fixing strength between the concrete and the embedded reinforcing steel bars. Therefore, it is a unique and reliable product that can provide convenience for construction engineering.

### BACKGROUND OF INVENTION

When it is needed to make additional construction to an existing building, the workers must firstly find the reinforcing steel bars at the position for additional construction, and use a hammer drill to remove the concrete covering the reinforcing steel bars at the positions for connection, so that the reinforcing steel bars are exposed for welding or connection. After adding the lengths of the original reinforcing steel bars, the workers need to encase them again with concrete. Only after the concrete is completely dry and hardened, further connection of the reinforcing steel bars and other engineering work can be carried out. However, such an engineering method is complicated, involving a series of engineering processes including destroying the concrete encasing the original reinforcing steel bars, welding or connection, and finally applying concrete again to encasing the reinforcing steel bars. Such processes require many working days and high engineering costs, and may cause dust pollution to the construction environment. Nowadays, as the construction industry is facing insufficient and high cost of labor, it is really necessary to improve the existing engineering method and find a convenient, fast and low-cost solution. Therefore, it is an aim for participators in this industry to design an innovative structure to shorten the engineering days for connecting the reinforcing steel bars and the concrete to 1-2 days while increasing the encasing strength and the embedding and fixing strength.

To this end, based on years of experience in research and development in the relevant field, the inventor of the present invention made in-depth analysis of the shortcomings of the existing engineering method and the requirements for improvement, and has persevered in his effort seeking possible solutions and carrying out tests. The present invention was finally accomplished to solve the problems of the prior art and make a practical innovation.

### SUMMARY OF THE INVENTION

It is therefore a primary object of the present invention to provide a “structure to enhance the embedding and fixing strength between the concrete and the extending component embedded inside the concrete”. The structure mainly includes an extending component designed with a central channel in its central part, and a plurality of transverse holes serially connected to the central channel from top to bottom. To bond the extending component with concrete, workers just need to fill anchoring adhesive into the above-mentioned central channel and the transverse holes, and the adhesive will fill up the space between the extending component and the concrete. After the extending component is embedded and fixed at the position where the reinforcing steel bars need to be extended, workers just need to connect reinforcing steel bars to the tip end of the extending component for extension of the concrete surface.

A secondary object of the present invention is to provide a “structure to enhance the embedding and fixing strength between the concrete and the extending component embedded inside the concrete”. To enhance the encasing strength and the embedding and fixing strength between the extending component and the concrete, the external surface of the extending component is formed with a protruding structure so that when anchoring adhesive is filled into the extending component, a stronger bonding can be formed between the adhesive and the concrete, thus enhancing the encasing strength and the embedding and fixing strength.

A further object of the present invention is to provide a “structure to enhance the embedding and fixing strength between the concrete and the extending component embedded inside the concrete”, wherein, the tip end of the extending component can be structurally designed to have a conic hole, a conic threaded hole or a threaded hole, and the tip end of the reinforcing steel bar to be connected can also be designed to have a matching structure, thus enhancing the strength of connection between the extending component and the reinforcing steel bar.

### BRIEF DESCRIPTION OF THE DRAWINGS

FIG. 1 is a perspective view of the present invention.

FIG. 2 is a sectional perspective of FIG. 1.

FIG. 3 is an operation view (I) of the present invention.

FIG. 4 is an operation view (II) of the present invention.

FIG. 5 is an operation view (III) of the present invention.

FIG. 6 is an operation view (IV) of the present invention.

FIG. 7 is a diagrammatic view of the present invention with a conic hole at the tip end.

FIG. 8 is a diagrammatic view of the present invention with a conic threaded hole at the tip end.

FIG. 9 is a diagrammatic view of the present invention with a threaded hole at the tip end.

FIG. 10 is a perspective view of the present invention with the transverse holes distributed at equal angular intervals.

FIG. 11 is a sectional view of the shaft part shown in FIG. 10.

FIG. 12 is a perspective view of another embodiment of the present invention.

FIG. 13 is a sectional view of FIG. 12.

FIG. 14 is an operation view (I) of another embodiment of the present invention.

FIG. 15 is an operation view (II) of another embodiment of the present invention.

FIG. 16 is an operation view (III) of another embodiment of the present invention.

FIG. 17 is an operation view (IV) of another embodiment of the present invention.

FIG. 18 is a perspective view of another embodiment of the present invention with the tip end formed with a conic hole.

FIG. 19 is a perspective view of another embodiment of the present invention with the tip end formed with a conic threaded hole.

FIG. 20 is a perspective view of another embodiment of the present invention with the tip end formed with a threaded hole.

FIG. 21 is a perspective view of another embodiment of the present invention with the transverse holes distributed at equal angular intervals.

FIG. 22 is a sectional view of the shaft part shown in FIG. 21.

### DETAILED DESCRIPTION OF THE INVENTION

For better understanding of the objects, effects, and structural features of the present invention, the following preferred embodiments are used for description, with reference to the accompanying drawings.

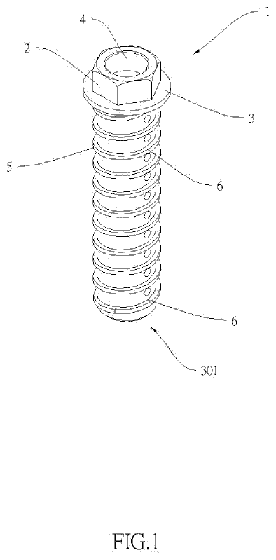

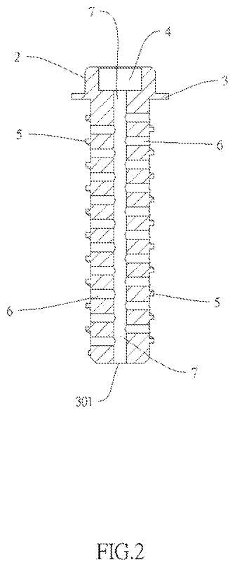

Firstly, please refer to FIG. 1 and FIG. 2, the present invention is a structure to enhance the embedding and fixing strength between the concrete and the extending component embedded inside the concrete, which mainly comprises an integrally formed extending component 1, wherein the top end of the extending component 1 has a tip end 2, the tip end 2 is in a hexagonal shape, having a hole 4 in its center, the bottom of the tip end 2 has an integrally formed platform 3, the central part of the platform 3 has an integrally formed shaft part 301, the external surface of the shaft part 301 has an integrally formed protruding structure 5, the center of the shaft part 301 has a central channel 7, the top end of the central channel 7 is communicated with the hole 4 on the tip end 2, a plurality of transverse holes 6 are distributed on both sides of the central channel 7 from top to bottom, communicated with the central channel 7, and the transverse holes 6 are distributed between one protruding structure 5 and another.

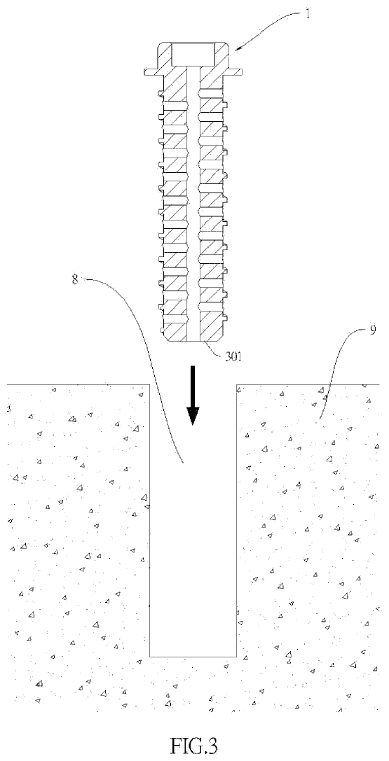

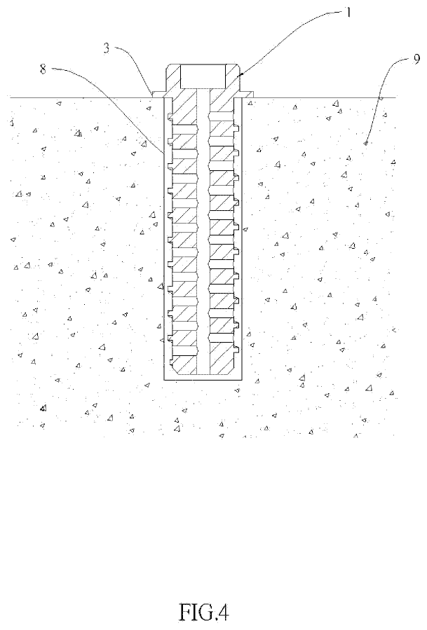

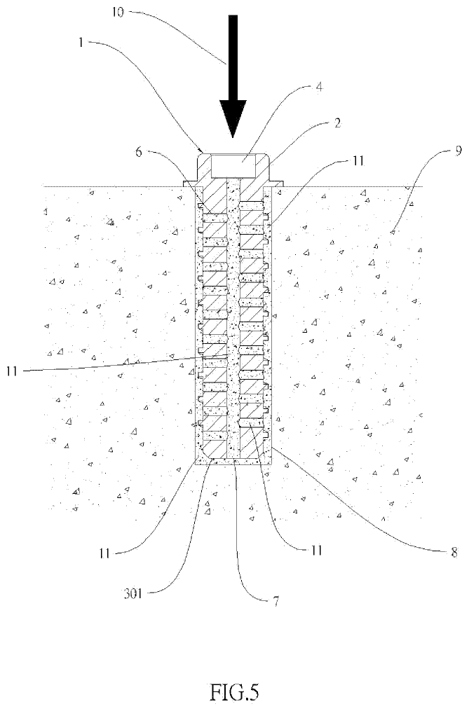

The use of the present invention is depicted in FIG. 3. When it is needed to extend the reinforcing steel bars inside the concrete 9 for additional construction, workers need to firstly drill a hole 8 slightly bigger than the diameter of the shaft part 301 of the extending component 1 at a position on the concrete 9 for reinforcing steel bar extension, then, place the extending component 1 into the hole 8 till the shaft part 301 of the extending component 1 is completely inside the hole 8, and the platform 3 of the extending component 1 is aligned with the plane of the hole 8 of the concrete 9 (see FIG. 4). Then, using an adhesive injecting device 10, the adhesive 11 is injected into the central channel 7 through the hole 4 on the tip end 2 of the extending component 1. After applying a pressure, the adhesive 11 can be transmitted from the central channel 7, and be squeezed through the plurality of transverse holes 6 communicated with the central channel 7 into the hole 8 inside the concrete 9. Continuously apply pressure upon the adhesive injecting device 10 till the adhesive 11 slightly spills out of the hole 4 on the tip end 2 and stop injection of the adhesive 11. Now the adhesive 11 has filled up the hole 8, completely bonding the extending component 1 with the concrete (see FIG. 5). As the shaft part 301 of the extending component 1 is formed with a protruding structure 5, when the adhesive 11 fills up the hole 8, the protruding structure 5 can enhance the bonding strength between the adhesive 11 and the hole 8 inside the concrete 9.

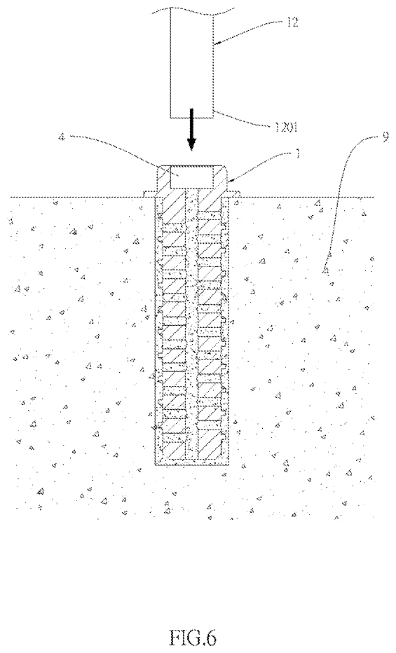

Referring to FIG. 6, when the adhesive 11 dries up, the reinforcing steel bars 12 and the concrete 9 can be extended. Because the hole 4 on the tip end 2 of the extending component 1 of the present invention is round and smooth, when it is needed combine a reinforcing steel bar 12 with the extending component 1, firstly process the end part 1201 of the reinforcing steel bar 12 into a round shape with its diameter slightly bigger than the hole 4 of the extending component 1, and then press the end part 1201 of the reinforcing steel bar 12 into the hole 4 of the extending component 1 for tight combination. In this way, the extending component 1 and the reinforcing steel bar 12 can be bonded together, and thus, the reinforcing steel bar 12 can be extended from the concrete 9 at the position for additional construction.

By adopting the above engineering method and the extending component 1 of the present invention, during engineering, workers no longer need to find out the reinforcing steel bars at the position for additional construction, and use a hammer drill to knock off the concrete encasing the reinforcing steel bar to expose the reinforcing steel bar, and then use welding or connection to increase the length of the original reinforcing steel bars, and then cover the steel bars with concrete, and conduct further connection of the reinforcing steel bars and other engineering operations after the concrete completely dries up.

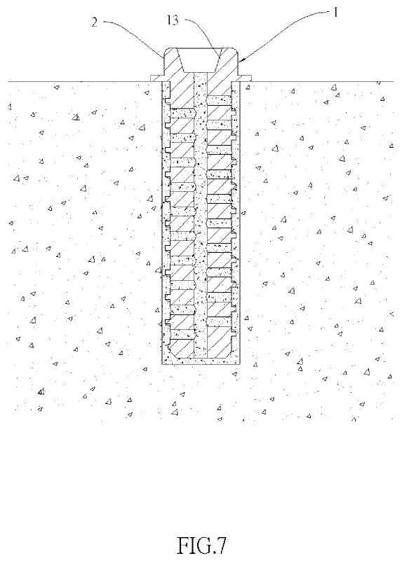

Referring to FIG. 7, the hole on the tip end 2 of the extending component 1 of the present invention can be formed as a conic hole 13. To combine the extending component 1 with the reinforcing steel bar 12 as depicted in FIG. 6, the end part 1201 of the reinforcing steel bar 12 can be processed into a conic shape, and conic embedding can be used to connect the end part 1201 of the reinforcing steel bar 12 with the conic hole 13 of the extending component 1.

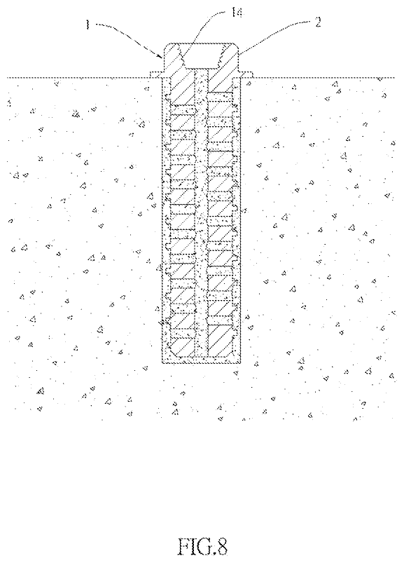

Referring to FIG. 8, the hole on the tip end 2 of the extending component 1 of the present invention can be formed as a conic threaded hole 14. To combine the extending component 1 with the reinforcing steel bar 12 as depicted in FIG. 6, the end part 1201 of the reinforcing steel bar 12 can be processed into a conic threaded shape, and conic embedding together with threaded connection can be used to connect the end part 1201 of the reinforcing steel bar 12 with the conic threaded hole 14 of the extending component 1.

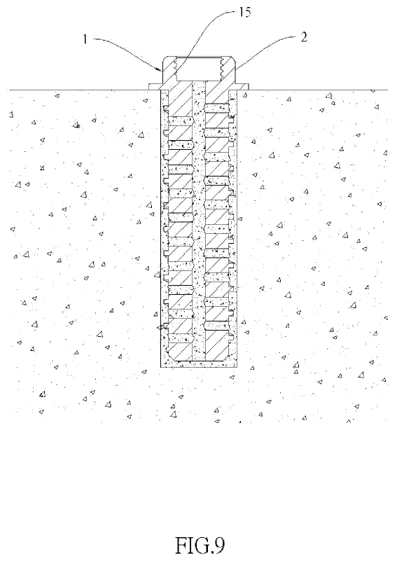

Referring to FIG. 9, the hole on the tip end 2 of the extending component 1 of the present invention can be formed as a threaded hole 15. To combine the extending component 1 with the reinforcing steel bar 12 as depicted in FIG. 6, the end part 1201 of the reinforcing steel bar 12 can be processed into a threaded shape, and threaded connection can be used to connect the end part 1201 of the reinforcing steel bar 12 with the threaded hole 15 of the extending component 1.

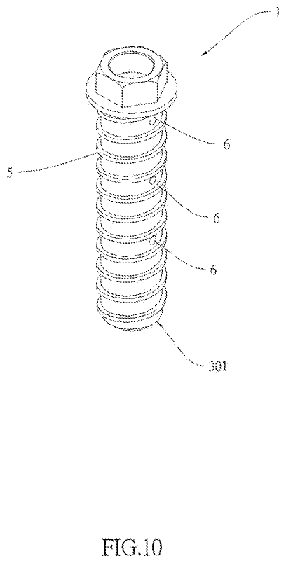

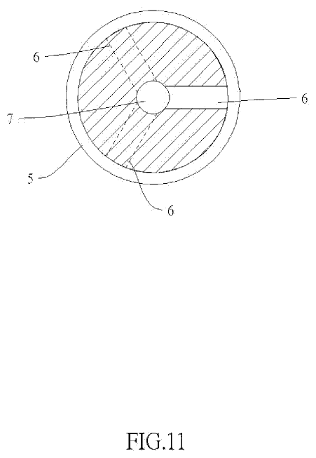

Referring to FIG. 10 and FIG. 11, the transverse holes 6 of the extending component 1 of the present invention are distributed at equal angular intervals on the shaft part 301 and are staggered from each other. When an adhesive injecting device 10 is used to inject the required adhesive 11 into the central channel 7 through the hole 4 on the tip end 2 of the extending component 1, under the applied pressure, the adhesive 11 will be transmitted quickly by the central channel 7, and the adhesive 11 will spill out of the shaft part 301 in all directions through the plurality of transverse holes 6 serially communicated with the central channel 7. Consequently, the hole 8 inside the concrete 9 can be filled with adhesive 11. This method can greatly speed up engineering and save labor.

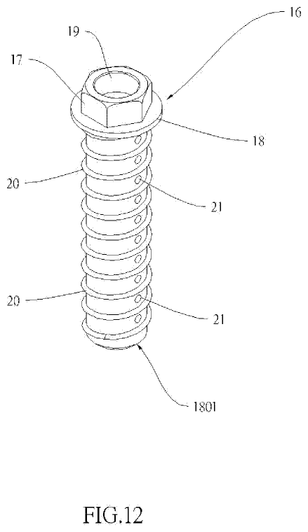

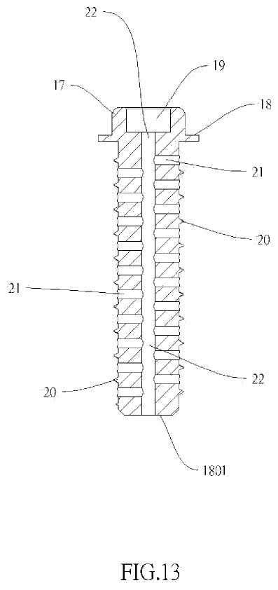

Refer to FIG. 12 and FIG. 13, which show another embodiment of the extending component disclosed in the present invention. The extending component 16 is an integrally formed body. The top end of the extending component 16 has a tip end 17. The tip end 17 is in a hexagonal shape, having a hole 19 in its center. The bottom of the tip end 17 has an integrally formed platform 18. The central part of the platform 18 has an integrally formed shaft part 1801. The external surface of the shaft part 1801 has integrally formed threaded parts 20. The shaft part 1801 has a central channel 22 in its center. The top end of the central channel 22 is communicated with the hole 19 on the tip end 17. A plurality of transverse holes 21 are distributed from top to bottom on both sides and communicated with the central channel 22. The transverse holes 21 are distributed between one threaded part 20 and another.

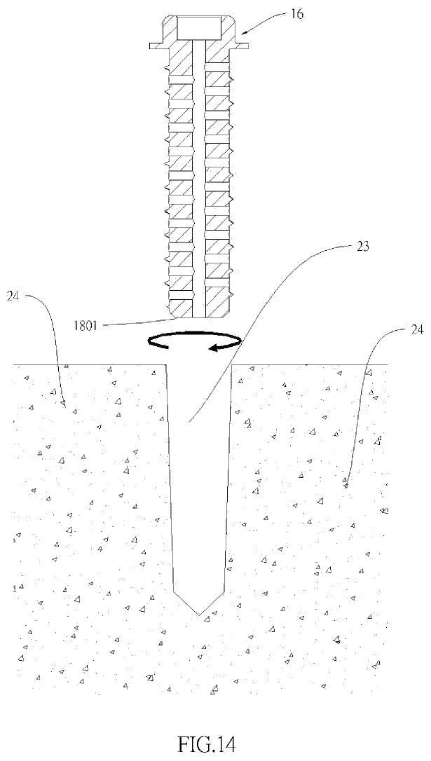

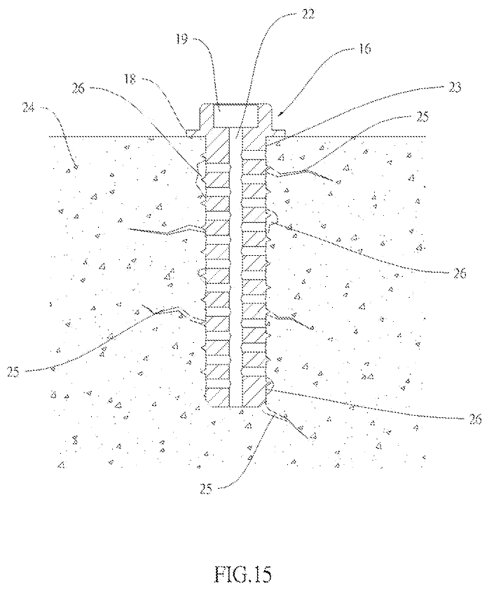

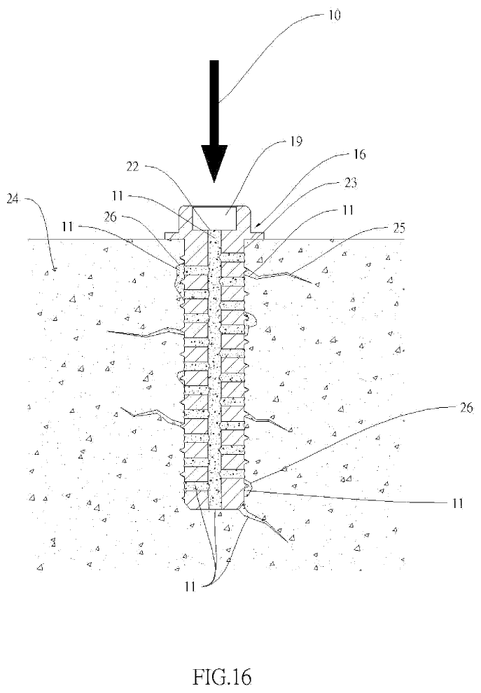

Referring to FIG. 14 for the operation, when it is needed to extend the reinforcing steel bars inside the concrete 24 for additional construction, workers firstly need to drill a hole 23 on the concrete 24 at the position for reinforcing steel bar extension. The diameter of the hole 23 shall be slightly bigger than the diameter of the shaft part 1801 of the extending component 16. Then, through the threaded part 20 on the extending component 16, workers can screw the extending component 16 into the hole 23, till the shaft part 1801 of the extending component 16 is fully fitted inside the hole 23, and the platform 18 of the extending component 16 is aligned to the plane of the hole 23 on the concrete 24 (see FIG. 15). Then, using an adhesive injecting device 10 (see FIG. 16), the required adhesive 11 is injected into the central channel 22 through the hole 19 on the tip end 17 of the extending component 16. Under an applied pressure, the adhesive 11 will fill up the central channel 22 and be quickly transmitted through the plurality of transverse holes 21 serially communicated with the central channel 22. When the extending component 16 is screwed into the hole 23 in the concrete 24 through the threaded part 20, it may often cause cracks 25 or collapse holes 26 in the concrete 24 (please refer to FIG. 15). Therefore, under the continuous pressure applied by the adhesive injecting device 10, the adhesive 11 inside the adhesive injecting device 10 will also fill up the cracks 25 or collapse hole 26 (see FIG. 16). When the adhesive 11 slightly spills out of the hole 19 on the tip end 17, stop injection of the adhesive 11. In this way, the adhesive 11 will not only fill up the central channel 22 inside the extending component 16 and the transverse holes 21, but also fill up the cracks 25 or collapse holes 26 caused when the extending component 16 is screwed into the concrete 24, thus bonding the extending component 16 completely with the concrete 24. As the shaft part 1801 of the extending component 16 is structured with a threaded part 20, when the adhesive 11 bonds the extending component 16 and the concrete 24 together, the structure of the threaded part 20 can strengthen the bonding between the extending component 16 and the concrete 24.

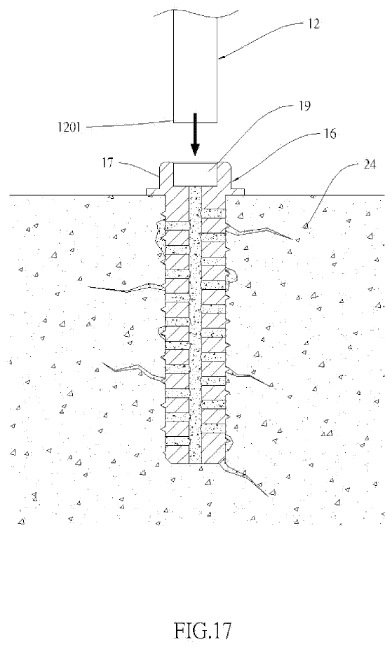

Referring to FIG. 17, when the adhesive 11 dries up, the reinforcing steel bars 12 and the concrete 24 can be extended. As the hole 19 on the tip end 17 of the extending component 16 of the present invention is a round a smooth hole, to connect the reinforcing steel bar 12 with the extending component 16, the end part 1201 of the reinforcing steel bar 12 shall be firstly processed into a round shape with its diameter slightly bigger than the hole 19 of the extending component 16, and the end part 1201 of the reinforcing steel bar 12 can be pressed into the hole 19 of the extending component 16 for tight fitting. In this way, the extending component 16 can be connected with the reinforcing steel bar 12, and reinforcing steel bars 12 can be extended from the concrete 24 at the position for additional construction.

By adopting the above engineering method and the extending component 16 of the present invention, during engineering, workers no longer need to find out the reinforcing steel bars at the position for additional construction, and use a hammer drill to knock off the concrete encasing the reinforcing steel bar to expose the reinforcing steel bar, and then use welding or connection to increase the length of the original reinforcing steel bars, and then cover the steel bars with concrete, and conduct further connection of the reinforcing steel bars and other engineering operations after the concrete completely dries up.

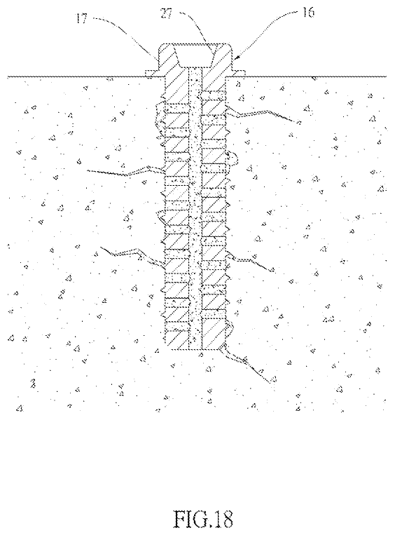

Referring to FIG. 18, the hole on the tip end 17 of the extending component 16 according to another embodiment of the present invention is a conic hole 27. When connecting the extending component 16 with the reinforcing steel bar 12 as shown in FIG. 15, the end part 1201 of the reinforcing steel bar 12 can be processed into a conic shape, and conic connection can be adopted to fit the end part 1201 of the reinforcing steel bar 12 into the conic hole 27 of the extending component 16.

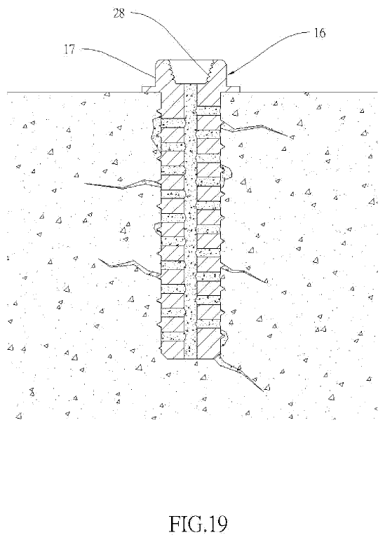

Referring to FIG. 19, the hole on the tip end 17 of the extending component 16 according to another embodiment is formed as a conic threaded hole 28. When it is needed to connect the extending component 16 with the reinforcing steel bar 12 as shown in FIG. 15, the end part 1201 of the reinforcing steel bar 12 can be processed into a threaded shape, and conic and threaded connection can be used to connect the end part 1201 of the reinforcing steel bar 12 with the conic threaded hole 28 of the extending component 16.

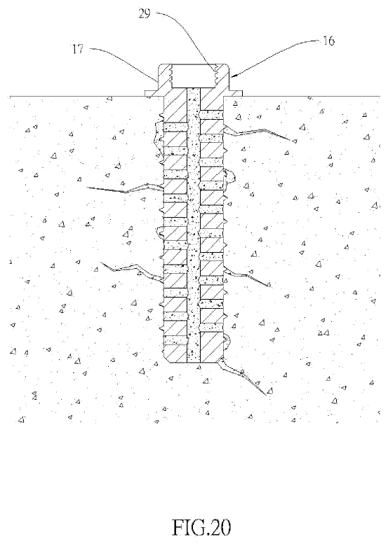

Referring to FIG. 20, the hole on the tip end 17 of the extending component 16 of the present invention is formed as a threaded hole 29. When it is needed to connect the extending component 16 with the reinforcing steel bar 12 as shown in FIG. 15, the end part 1201 of the reinforcing steel bar 12 can be processed into a threaded shape, and threaded connection can be used to connect the end part 1201 of the reinforcing steel bar 12 with the threaded hole 29 of the extending component 16.

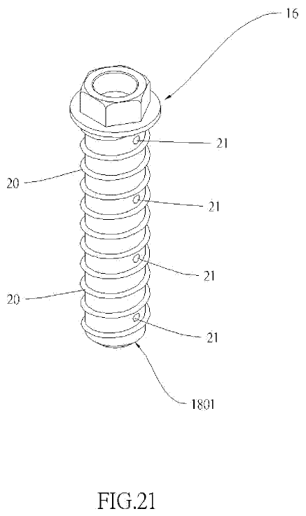

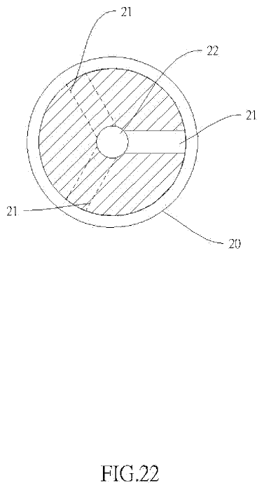

Referring to FIG. 21 and FIG. 22, the transverse holes 21 on the extending component 16 of the present invention are distributed on the shaft part 1801 at equal angular intervals and are staggered from each other. Through an adhesive injecting device 10, the required adhesive 11 can be injected from the hole 19 on the tip end 17 of the extending component 16 and into the central channel 22. When a pressure is applied, the adhesive 11 can be quickly transmitted by the central channel 22, and through the plurality of transverse holes 21 serially connected to the central channel 22, the adhesive 11 can spill out of the shaft part 1801 in all directions. In this way, the hole 23 inside the concrete 9 can be quickly filled up by the adhesive 11, and the engineering process can be completed with less time.

To conclude, the structure disclosed in the present invention to enhance the embedding and fixing strength between the concrete and the extending component embedded inside the concrete is deliberately designed by the inventor, and is practical and convenient for quick engineering to shorten working days. Moreover, it will not cause powder pollution to the environment. Therefore, as the present invention meets the prerequisites for invention patent as prescribed in the patent law, an application is filed. Your examination and approval will be highly appreciated.

Although the invention has been explained in relation to its preferred embodiment, it is to be understood that many other possible modifications and variations can be made without departing from the spirit and scope of the invention as hereinafter claimed.

Reference numerals

| | | | |
|---|---|---|---|
| 1 | extending component | 2 | tip end |
| 3 | platform | 301 | shaft part |
| 4 | hole | | |
| 5 | protruding structure | 6 | transverse holes |
| 7 | central channel | 8 | hole |
| 9 | concrete | 10 | adhesive injecting device |
| 11 | adhesive | 12 | reinforcing steel bar |
| 1201 | end part | | |
| 13 | conic hole | 14 | conic threaded hole |
| 15 | threaded hole | 16 | extending component |
| 17 | tip end | | |
| 18 | platform | 1801 | shaft part |
| 19 | hole | 20 | threaded part |
| 21 | transverse holes | 22 | central channel |
| 23 | hole | 24 | concrete |
| 25 | cracks | 26 | collapse hole |
| 27 | conic hole | 28 | conic threaded hole |
| 29 | threaded hole | | |

What is claimed is:

1. A structure to enhance the embedding and fixing strength between the concrete and the extending component embedded inside the concrete, mainly including an integrally formed extending component, the top end of the extending component having a tip end, said tip end being formed in a hexagonal shape, with a hole in its center, the bottom of the tip end having an integrally formed platform, the center of the platform having an integrally formed shaft part, characterized in that:
the external surface of the shaft part has an integrally formed protruding structure,
the center of the shaft part has a central channel,
the top end of the central channel is communicated with the hole of the tip end, on both sides of the central channel,
a plurality of transverse holes communicating with the central channel are configured from top to bottom, and
the transverse holes are distributed between one protruding structure and another.

2. The structure to enhance the embedding and fixing strength between the concrete and the extending component embedded inside the concrete defined in claim 1,
wherein the hole on the tip end can be formed as a conic hole.

3. The structure to enhance the embedding and fixing strength between the concrete and the extending component embedded inside the concrete defined in claim 1,
wherein the hole on the tip end can be formed as a conic threaded hole.

4. The structure to enhance the embedding and fixing strength between the concrete and the extending component embedded inside the concrete defined in claim 1,
wherein the hole on the tip end can be formed as a threaded hole.

5. The structure to enhance the embedding and fixing strength between the concrete and the extending component embedded inside the concrete defined in claim 1,
wherein the transverse holes are distributed at equal angular intervals on the shaft part, and are staggered from each other.

6. A structure to enhance the embedding and fixing strength between the concrete and the extending component embedded inside the concrete, which mainly comprises an integrally formed extending component, wherein the top end of the extending component has a tip end, the tip end is in a hexagonal shape, having a hole in its center, and the bottom of the tip end has an integrally formed platform, the central part of the platform has an integrally formed shaft part, and the external surface of the shaft part has an integrally formed threaded part, characterized in that:
the center of the shaft part has a central channel,
the top end of the central channel is communicated with the hole of the tip end, on both sides of the central channel, and
a plurality of transverse holes are distributed from top to bottom, all communicating with the central channel, and the transverse holes are distributed between one threaded part and another.

7. The structure to enhance the embedding and fixing strength between the concrete and the extending component embedded inside the concrete defined in claim 6,
wherein the hole on the tip end can be formed as a conic hole.

8. The structure to enhance the embedding and fixing strength between the concrete and the extending component embedded inside the concrete defined in claim 6,
wherein the hole on the tip end can be formed as a conic threaded hole.

9. The structure to enhance the embedding and fixing strength between the concrete and the extending component embedded inside the concrete defined in claim 6,
wherein the hole on the tip end can be formed as a threaded hole.

10. The structure to enhance the embedding and fixing strength between the concrete and the extending component embedded inside the concrete defined in claim 6,
wherein the transverse holes are distributed at equal angular intervals on the shaft part, staggered from each other.
